(19) United States
(12) Patent Application Publication
(10) Pub. No.: US 2004/0060241 A1
(43) Pub. Date: Apr. 1, 2004

(54) Prehung door installation aid

(76) Inventors: Donald E. Staples, Cape Girardeau, MO (US); J. Christian Staples, St. Charles, MO (US); Jeffrey T. Staples, Aldie, VA (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/260,204

(22) Filed: Sep. 30, 2002

(51) Int. Cl. E06B 3/32

(52) U.S. Cl. 49/380; 206/325

(57) ABSTRACT

A one-piece, unitary installation aid is provided for holding a door in place relative to a door frame in a pre-hung door assembly during transportation and installation of the door assembly in a building. The installation aid includes a wall having a inner surface and an outer surface, a door clip extending from the wall inner surface and a jamb clip extending from the wall outer surface. The door clip is sized to fit over the door, and the jamb clip is sized to fit over the jamb. The door clip and jamb clip interact with the door and the jamb, respectively, to positively hold the door closed in the frame and to prevent pivoting of the door in the frame.

### CROSS-REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE APPLICATION

This invention relates to doors which are prehung on a door frame, and, in particular to an installation aid which will hold an exterior door closed and square during shipping, delivery, and installation of the prehung door.

The building industry has, for many years, provided to contractors, carpenters, and do-it-yourselfers doors that are prehung on frames. The prehung door typically includes a door, a door frame, and two or three hinges which connect the door to the frame. The frame may be a single frame or a two-piece split frame. The machining or manufacturing of the door and frame to accept the hinges and preparation of the lock and strike are done in a manufacturing facility using equipment specifically designed for this purpose. During production of the door assembly, the complete exterior door frame, comprised of two side jambs, a head jamb and a sill are assembled together to form a frame around the door.

When the complete frame is assembled, the hinges provide proper spacing between the door and the hinge jamb. However, the door can swing relative to the door frame. Without the door held in place in the door frame, if the door does swing out of the plane of the door, the door frame may no longer be square. As can be appreciated, it is difficult to install a door assembly when the door is swinging out of the frame, rather than secured in the frame. To overcome this, manufacturers have driven the nails through the back of the strike jamb into the door closed in the frame. Because the nails have to be removed prior to installation of the door assembly, the door installer must square the door in the door frame so that the door will operate properly and easily. When the nails are removed, there is nothing holding the door closed in the frame. As a result, installation of the pre-hung door assembly can be difficult. Further, it is difficult to obtain the proper spacing between the door and the frame members. All this also makes it exceedingly difficult for one person to install the door assembly by himself. Additionally, the use of the nails leaves undesirable nail holes in the door and the strike jamb.

A clip has been sold to hold the door closed during transportation and installation. This clip is generally F-shaped. The two parallel arms of the “F” are sized to fit over the edge of the strike jamb, and the leg extends across the front surface of the door. However, this clip does not work well to prevent pivoting of the door in the frame.

In our prior U.S. Pat. Nos. 5,722,203 and 6,170,198, both of which are incorporated herein by reference, we disclosed a prehung door installation aid to hold the doors in place relative to the door during installation of the door as well as during shipping of the door. Both of these devices work well. However, they require two pieces—one which fits in the door and one which fits in the strike jamb.

### SUMMARY OF THE INVENTION

Briefly stated, a unitary, one-piece installation aid is provided for maintaining a door closed in a door frame during transportation of a door assembly and installation of the door assembly in a building. The installation aid can be used with both interior and exterior doors. As is known, a door assembly includes a frame in which a door is pivotally mounted. The door frame includes a strike jamb having a pocket formed therein to receive a latch plate. The door includes an edge, a door knob hole spaced inwardly from the edge and extending between opposing surfaces of the door, and a latch bore extending from the door edge to the door knob opening. The door latch bore and the jamb pocket are generally aligned with each other.

The installation aid includes a wall having a inner surface and an outer surface. A door clip extends from the wall inner surface and a jamb clip extends from the wall outer surface. The door clip is sized to fit over the door, and the jamb clip is sized to fit over the jamb.

The door clip includes a pair of spaced apart arms extending from the wall inner surface. A finger extends from an end of each arm such that the fingers face each other. Preferably, the inner surfaces of the fingers are convex and have a curvature corresponding generally to the curvature of the door knob hole. The door clip has a length from the wall inner surface to the finger approximately equal to the distance between the door edge and an edge of a door knob hole so that when the door clip is applied to the door, the door clip will snuggly grasp the door. The door includes a sunken portion in the door edge around the latch bore. This sunken area can extend across the door edge. To accommodate doors in which the sunken area extends across the door edge, the door clip includes a stand-off extending from the wall inner surface and positioned to be received in the door edge sunken portion. The stand-off has a height approximately equal to the depth of the door edge sunken portion. The door clip also includes a locator extending from the wall inner surface between the clip arms. The locator is sized and shaped to be snuggly received in the door latch bore.

The jamb clip includes a first leg extending from the wall outer surface and a second leg extending upwardly from the first leg. The first leg has a length from the wall to the second leg which is slightly greater than the width of the door jamb. The second leg is flexible, and is preferably angled toward the wall. Hence, the second leg will positively frictionally grip the jamb. To increase the frictional grip of the jamb clip on the jamb, the jamb clip includes at least one protrusion on the second leg inner surface. To prevent the jamb clip from sliding off the jamb, the jamb clip includes a locator on the wall outer surface sized and positioned to be received in the strike jamb pocket. The jamb clip locator has a depth approximately equal to the depth of the door jamb pocket. To facilitate installation of the aid, a ramp is provided along one side of the jamb clip locator. The jamb clip can also be provided with a hole in the jamb clip second leg, through which a fastener, such as a threaded member or a nail, can extend into the jamb. The jamb clip can also be provided with an angled tail, which extends from the top of the first leg, away from the central wall. This angled tail eases installation of the jamb clip over the door frame strike jamb.

### BRIEF DESCRIPTION OF THE DRAWINGS

FIG. 1 is a perspective view of a pre-hung door assembly;

FIG. 2 is a front perspective view of an installation aid of the present invention;

FIG. 3 is a rear perspective view of the installation aid;

FIG. 4 is a side elevational view of the installation aid;

FIG. 5 is a front elevational view of the installation aid;

FIG. 6 is a top plan view of the installation aid; and

FIG. 7 is a cross-sectional view of the installation aid installed in a door assembly.

### Corresponding reference numerals will be used throughout the several figures of the drawings.

### DESCRIPTION OF THE PREFERRED EMBODIMENT

The following detailed description illustrates the invention by way of example and not by way of limitation. This description will clearly enable one skilled in the art to make and use the invention, and describes what we presently believe is the best mode of carrying out the invention.

A typical prehung door assembly 10 includes a door 12 which is mounted in a frame 14. As is known, the frame 14 for an exterior door includes a hinge jamb 16 to which the door is mounted by hinges 18, a head jamb 20, a strike jamb 22, and a sill 24. The head jamb 22 and sill 24 extend across the top and bottom of the door, respectively, to connect the hinge and strike jambs together. The door 12 includes a door knob hole 26 which extends between the front and back faces 28, 30 (FIG. 7) of the door, and a latch bore 32 in the side edge 34 of the door 12 through which the door knob latch extends. Typically, the area around of the latch bore 32 is sunken, as at 36, relative to the edge 34 of the door 12. This provides a predefined or preformed spot for the installer to secure a strike plate on the door. The strike jamb 22 also has a routed pocket 38 on its inner surface which is formed by the manufacturer to accept a strike plate and door latch.

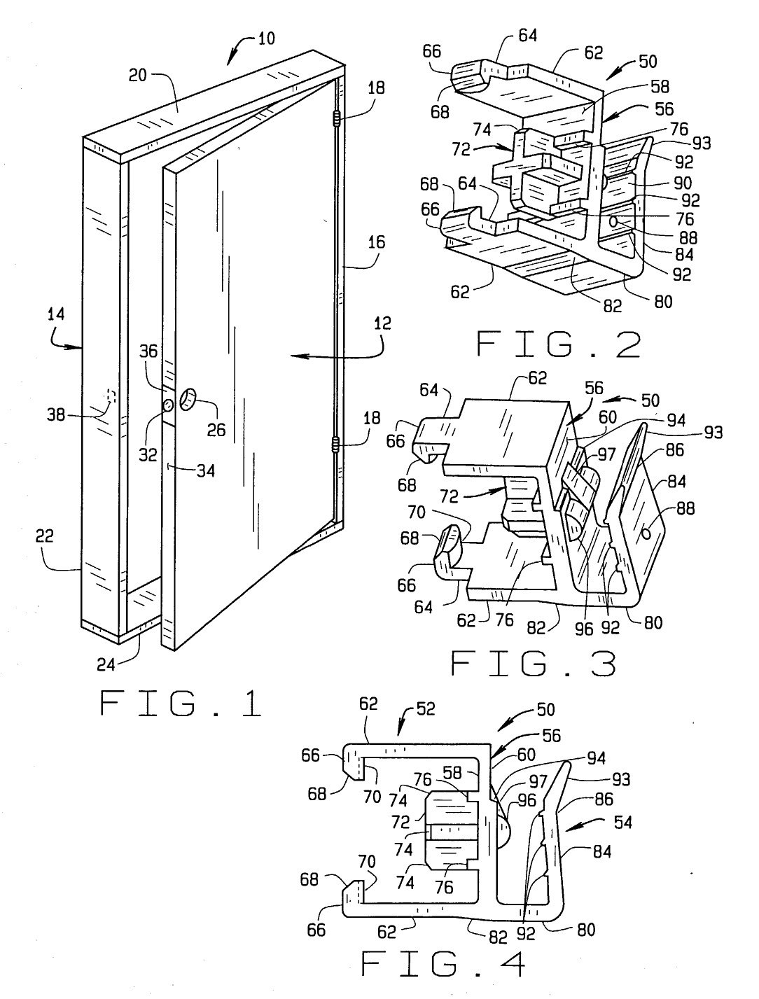

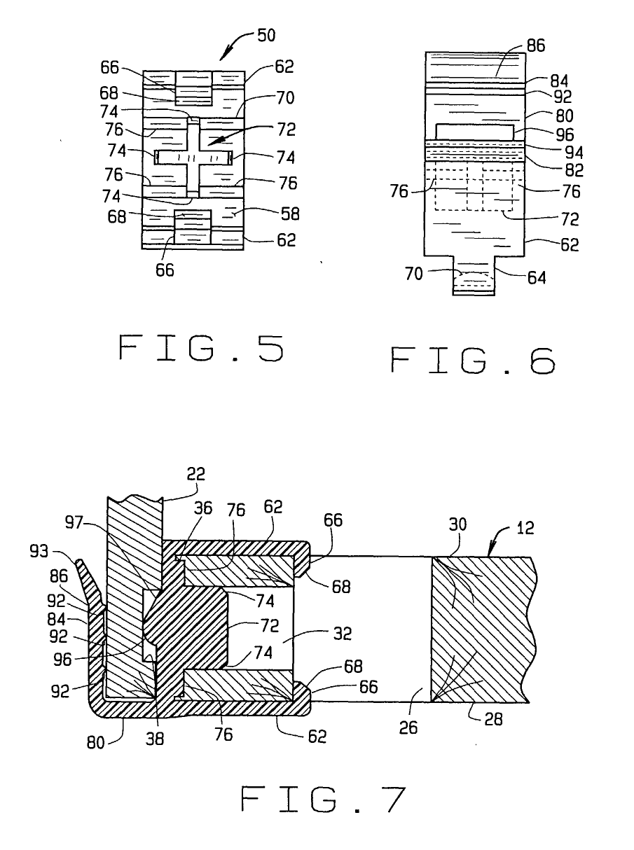

An illustrative embodiment of the installation aid 50 of the present invention is shown generally in FIGS. 2-7. The installation aid 50 is preferably molded of plastic as a single, unitary piece. The plastic is preferably a soft plastic or resin, such as a low temperature or medium temperature copolymer polypropylene. Such a plastic is more flexible (and less brittle) to allow for easier application of the aid 50 to the door assembly 10, as will be described below. Additionally, the use of a softer plastic or resin will reduce the possibility of the installation aid 50 marring the door 12 or the door frame 14 during installation of the aid 50 on the door assembly or removal of the aid 50 from the door assembly.

The aid 50 can be described to include two portions: a first portion or door clip 52 which fits over the edge 34 of the door 12 and a second portion or jamb clip 54 which fits over the front edge of the strike jamb 22. The two clips extend from opposite sides of a wall 56 having inner and outer surfaces 58 and 60, respectively. The door clip portion 52 is generally C-shaped, and includes upper and lower arms 62 which extend from the inner surface 58 of the wall 56. The arms 62, at their bases (i.e., at the wall inner surface 58) are spaced apart a distance slightly greater than the width of the door 12. The arms 62 are not parallel to each other. Rather, they angle slightly inwardly, and are flexed when the aid 50 is applied to the door 12.

A tab 64 extends forwardly from the end of each arm 62. The tab 64 is generally centered with respect to the arm 62. A finger 66 extends from the inner surfaces of each tab 64, such that the two fingers 66 face, or extend toward, each other. The fingers 66 have an outer surface that is sloped or beveled, as at 68, and an inner surface 70 that is curved, as best seen in FIG. 3. Preferably, only a portion of the finger outer surface is beveled. However, the entire outer surface could be sloped, giving the finger a generally triangular appearance in side elevation. The curvature of the inner surface 70 preferably corresponds substantially to the curvature of the door knob hole 26 in the door 12. The combined length of the arms 62 and the tabs 64 are such that, when the aid 50 is applied to the door 12, the inner surface 58 of the wall 56 will contact the door edge 34 and the tab inner surfaces 70 will engage the edge of the door knob hole 26, as seen in FIG. 7. To fit a standard door, the distance from the wall inner surface 58 to the tab inner surface 70 is about 1.385″ at the center of the inner surface 70.

A locator 72 extends from the wall inner surface 58 approximately midway between the two arms 62. The locater 72 is also preferably generally centered transversely between the elongate sides of the wall 56. The locator 72 is sized and shaped to be received in the door latch bore 32. Hence, if a circle were scribed around the locator 72, such a circle would have a diameter of about 1″. The locator 72 is shown to have a “+” shape. However, it could be circular, triangular, square, rectangular, or any other desired shape. The locator 72, when received in the door latch bore 32, will prevent the aid from moving along the edge of the door 12. Thus, to prevent movement of the aid 12, the locator 72 can be any desired shape which has at least two edges positioned to be in close proximity to the edge of the door latch bore 32 when the aid 50 is applied to the door 12. To facilitate mounting of the aid to the door, the edges of the locator 72 are preferably beveled, as at 74.

The aid 50 also includes stand-offs 76 which extend laterally between the elongate edges of the wall inner surface 58 and the locator 72. Four stand-offs 76 are shown, there being two opposing stand-offs at the upper and lower ends of the +-shaped locator. The stand-offs 76 are sized to have a depth that corresponds to the depth of the sunken area 36 surrounding the door latch bore 32. To be applied to a standard door, the stand-offs 76 have a depth of about ⅛″. In some door frames, the sunken section 36 is formed by a mortise in the door edge 34. In this case, the sunken section 36 only extends partway across the door edge. However, in other doors, a pair of facing sections are applied to the door edge above and below the latch bore 32. In this instance, the sunken section 36 extends fully across the door edge 32. As can be appreciated, for the aid 50 to properly fit the door, the aid relies on the distance between the door outer surface and the edge of the door knob hole 26. In the aid 50, this distance is provided by the distance between the wall inner surface 58 and the tab finger inner surface 70. The stand-offs 76 are provided to ensure that, in the second noted type of door, that the wall inner surface 58 will be at the level of the door edge 34. Otherwise, the wall inner surface will be received in the sunken section itself, and the fingers 66 will not properly engage the door knob hole 26. The stand-offs 76 are shown to be generally rectangular. However, they can be most any desired shape. For example, and without limitation, the stand-off 76 can be a rib which surrounds the locator 72 or as discrete pegs which extend from the wall inner surface 58.

The jamb clip 54 includes a leg 80 which extends from the outer surface 60 of the wall 56. The leg 80 is generally co-planar with the door clip bottom arm 62. However, as seen, the leg 80 of the jamb clip is slightly wider than the door clip arm 62. As best seen in FIG. 2, there is a sloped surface 82 which forms the transition between the leg 80 and the bottom arm 62. Preferably, the sloped surface ends at a point approximately beneath the wall inner surface 58. That is, the width of the leg 80 extends beneath the wall 56.

A flexible arm 84 extends upwardly from the end of the leg 80. The arm 84 is preferably sloped slightly inwardly towards the wall 56. The leg 80 is sized such that opposite sides of the strike jamb are frictionally gripped, engaged or contacted by the wall outer surface 60 and the inner surface 90 of the arm 84, as seen in FIG. 7. To fit a standard jamb, which has a width of 0.625″, the leg 80 has a length of about 0.8″. The outer surface of the arm 84 is generally flat, and the arm 84 is preferably beveled at the top of the outer surface, as at 86. A screw hole 88 can be provided in the arm 84, if desired. The inner surface 90 of the arm 84 is preferably provided with ribs 92 which are shown to traverse the arm inner surface. As will be discussed below, the ribs 92 are provided to increase the frictional grip of the jamb clip 54 of the aid 50 on the jamb 22. Although not preferred, the ribs could be omitted. Alternatively, the ribs could be provided with other protruding elements, such as pegs or raised bumps, which will perform the same function.

An angled tail 93 can be provided at the free end of the leg 84. The tail 93 extends outwardly from the leg 84 (away from the wall 56). As will be explained below, when the aid is installed on the door, and the door is being closed in the frame to fit the jamb clip 54 over strike jamb, the tail 93 will engage the strike jamb; causing the leg 84 to flex outwardly from the wall 56 prior to the leg 54 engaging the strike jamb. Thus, the tail 93 facilitates application of the aid 50 to a door assembly 10.

The wall 56 is stepped, as at 94, to increase the width of the wall from a point approximately opposite the upper set of stand-offs 76 to the bottom of the wall. A jamb locator 96 extends from the wall outer surface 56 on the thickened portion of the wall (i.e., below the step 94) and generally opposite the door locator 72. The jamb clip locator 96 is sized and shaped to be received in the routed out pocket 38 that is cut into the strike jamb by the manufacturer to later accommodate the strike plate and the door latch. Preferably, the strike jamb locator is an elongate member having sloped upper and lower walls. It forms, in effect, a rounded off triangle, a dome, or even a semi-circle in side elevation. The height of the locator 96 is sized to be received in a standard jamb pocket 38. Preferably, it has a height of about 0.187″. The length of the jamb locator 96 is sized such that its extends substantially the full width of the strike jamb pocket 38. The jamb clip locator 96 is designed to prevent the door 12 from pivoting relative to door frame. It's rounded edges allow for easier installation and removal of the clip from the door frame. To further facilitate installation of the jamb clip on the jamb, a ramp 97 is formed on the side of the locator opposite the jamb clip first leg 82 (i.e., the open side of the clip). When the jamb clip is applied to the strike jamb, the ramp 97 engages the inner side of the jamb (i.e., the side of the jamb adjacent the door when the door is closed). The ramp 97 reduces the degree of the slope which the strike jamb is otherwise subjected to when the clip is applied to the jamb. By effectively reducing the slope which the jamb must ride over as the clip is applied to the jamb, installation of the jamb clip to the jamb is made easier.

The installation aid 50 is applied to the door assembly 10 by the manufacturer. Installation is quick and simple. First, the aid 50 is applied to the door by pressing the door clip 52 over the door edge 34 with the door clip locator 72 generally aligned with the door latch bore 32. When the door clip is applied to the door, the door clip arms 62 flex outwardly, and, when the finger inner surface 70 passes over the edge of the door knob hole 26, the arms 62 snap against the opposing surfaces of the door, and the fingers snap into the door knob hole. As discussed above, the door clip 52 of the aid 50 is sized such that, when the fingers 66 are in the door knob hole, the installation aid 50 cannot move substantially inwardly or outwardly relative to the door. As can be appreciated, due to manufacturing tolerances, the door clip 52 will have a slight play in its position relative to the door 12. Further, the slight inward slope of the arms 60 create a pressure against the door faces once the fingers are in place, assisting holding the door clip in place. Additionally, as noted above, the door clip locator 72 is sized relative to the door latch bore to substantially prevent vertical movement of the aid 50 relative to the door.

After the aid 50 has been installed on the door 12, the door can simply be shut against the jamb 22. As the door is shut, jamb clip leg 84 will flex outwardly as the door jamb clip 54 engages the jamb 22. The tail 93 (if included) will first engage the jamb. As the tail slides over the outer edge of the jamb, the engagement of the tail 93 with the jamb will cause the jamb clip to open, thereby facilitating application of the jamb clip to the jamb. As the jamb clip itself engages the jamb, the ramp 97 will engage the inner surface of the jamb. As noted above, the slope of the ramp is less than the slope of the locator. When the door is fully shut, the jamb clip locator 96 will be received in the strike jamb pocket 38. When this happens, the spring action of the arm 84 will snap the locator 96 into the jamb pocket 38. In this position, the jamb will be frictionally engaged by the wall outer surface 60 and the jamb clip arm 84. The ribs 92 on the arm inner surface 90 increase the frictional grip of the jamb clip on the jamb 22 by applying pressure to the back side of the jamb. This allows the jamb clip to better resist slipping off the jamb.

When the installation aid 50 has been properly mounted to the door assembly, it positively holds the door shut, and prevents the door 12 from swinging relative to the frame. Although not necessary, a fastener, such as a screw or nail, can be passed through the hole 88 in the jamb clip leg 84 and into the jamb itself. Because this portion of the jamb will be enclosed by the wall in which the door frame is mounted, this fastener will not affect the aesthetic appearance of the arm.

Although not required, the noted beveled or sloped surfaces on the fingers 66, the arm 80, and locators 72 and 96 facilitate mounting of the installation aid 50 on the door and strike jamb.

The door assembly can be installed with the installation aid in place, and the installation aid 50 can be removed from the door assembly after it is installed. When installed, there is a clearance between the door frame 14 and the studs of the wall in which the door assembly is mounted. To remove the installation aid, a tool, such as a screw driver, is used to flex the jamb clip arm 84 away from the jamb 22. At the same time, the door is pushed open. This will remove the installation aid from the jamb 22. As can be appreciated, if a fastener has been passed through the jamb clip arm 84 and into the jamb, this fastener should be removed prior to installation of the door assembly 10 into a wall. The installation aid is removed from the door 12 after it has been removed from the jamb by flexing one or both of the door clip arms 62 sufficiently to allow the installation aid to be pulled off the door.

As can be appreciated, the installation aid 50 of the present invention is installed in the door assembly by the manufacturer and removed from the door assembly by the installer without marring the door. It thus leaves no visible marks on the door or door frame. Because the aid positively retains the door in place relative to the strike jamb, the door cannot pivot on its hinges relative to the strike jamb during transportation or installation. The door assembly can therefore be installed by a single individual. Further, because the door assembly is installed in a doorway in its closed position, the manufacturer can square the door in the door frame prior to shipping. The door assembly, as installed will therefore be squared and the installer will not have to square the door in the door frame. This obviously eliminates a difficult step for the do-it-yourselfer.

As variations within the scope of the appended claims may be apparent to those skilled in the art, the foregoing description is set forth only for illustrative purposes and is not meant to be limiting. For example, the arms 62 could be extended such that the fingers 66 extend from the end of the arm, thereby eliminating the tabs 64. The width of the arm 62 could be changed so that it is narrower. As second ramp could be provided on the opposite side of the jamb clip locator to facilitate removal of the clip from the jamb. These examples are merely illustrative.

I claim:

1. An installation aid for maintaining a door closed in a door frame during transportation and installation of a door assembly in a building, said installation aid comprising:
a wall having a inner surface and an outer surface, a door clip extending from said wall inner surface and a jamb clip extending from said wall outer surface;
said door clip including a pair of spaced apart arms extending from said wall inner surface; and a finger extending from an end of at least one of said arms and toward the opposite arm, said door clip having a length from said wall inner surface to said finger approximately equal to the distance between an edge of a door and an edge of a door knob hole in the door; and
said jamb clip including a first leg extending from said wall outer surface and a second leg extending upwardly from said first leg, said first leg having a length from said wall to said second leg which is slightly greater than the width of a door jamb.

2. The installation aid of claim 1 wherein said door clip includes a stand-off extending from said wall inner surface.

3. The installation aid of claim 1 wherein said door clip includes a tab extending from said arms; said fingers extending from the ends of said tabs.

4. The installation aid of claim 1 wherein the inner surfaces of said fingers are convexly curved.

5. The installation aid of claim 1 wherein said door clip includes a locator extending from said wall inner surface between said arms.

6. The installation aid of claim 5 wherein said locator is generally “+”-shaped.

7. The installation aid of claim 1 wherein said jamb clip second leg is angled toward said wall.

8. The installation aid of claim 1 wherein said jamb clip second leg has an inner surface, said jamb clip including at least one protrusion on said second leg inner surface.

9. The installation aid of claim 1 including a jamb clip locator on said wall outer surface; said jamb clip locator having a depth approximately equal to the depth of the pocket formed in a standard door jamb.

10. The installation aid of claim 9 wherein said jamb clip includes a ramp extending generally perpendicularly to an axis of said locator; said ramp having a slope less than the slope of said jamb clip locator.

11. The installation aid of claim 1 including a tail which extends from an end of said jamb clip second let; said tail extending outwardly from said jamb clip second leg.

12. An installation aid for maintaining a door closed in a door frame during transportation and installation of a door assembly in a building, said installation aid comprising:
a wall having a inner surface and an outer surface, a door clip extending from said wall inner surface and a jamb clip extending from said wall outer surface;
said door clip including a pair of spaced apart arms extending from said wall inner surface; a finger extending from an end of each said arm such that said fingers face each other; and a locator extending from said wall inner surface between said arms; and
said jamb clip including a first leg extending from said wall outer surface and a second, flexible, leg extending upwardly from said first leg; said second leg being angled toward said wall.

13. The installation aid of claim 12 wherein said jamb clip includes a locator on said wall outer surface.

14. In combination, a door assembly and an installation aid; said door assembly including a door frame having at least a strike jamb and a door pivotally mounted in said door frame; said door including an edge, a door knob hole spaced inwardly from said edge and extending between opposing surfaces of said door, and a latch bore extending from said door edge to said door knob opening; said strike jamb including a pocket positioned on said strike jamb to be generally aligned with said door latch bore;
said installation aid comprising a wall having a inner surface and an outer surface, a door clip extending from said wall inner surface and a jamb clip extending from said wall outer surface;
said door clip including a pair of spaced apart arms extending from said wall inner surface; and a finger extending from an end of each said arm such that said fingers face each other, said door clip having a length from said wall inner surface to said finger approximately equal to the distance between said door edge and an edge of a door knob hole; and
said jamb clip including a first leg extending from said wall outer surface and a second leg extending upwardly from said first leg, said first leg having a length from said wall to said second leg which is slightly greater than the width of the door jamb.

15. The combination of claim 14 wherein said door includes a sunken portion extending across said door edge; said door clip including a stand-off extending from said wall inner surface and positioned to be received in said door edge sunken portion; said stand-off having a height approximately equal to the depth of said door edge sunken portion.

16. The combination of claim 14 wherein said door clip fingers have an inner surface, said finger inner surface being convex and having a curvature corresponding generally to the curvature of said door knob hole.

17. The combination of claim 14 wherein said door clip includes a locator extending from said wall inner surface between said arms, said locator being sized and shaped to be received in said door latch bore.

18. The combination of claim 14 wherein said jamb clip second leg is angled toward said wall.

19. The combination of claim 14 wherein said jamb clip second leg has an inner surface, said jamb clip including at least one protrusion on said second leg inner surface.

20. The combination of claim 14 including a jamb clip locator on said wall outer surface; said jamb clip locator having a depth approximately equal to the depth of the door jamb pocket.

21. The combination of claim 14 including a hole extending through said jamb clip second leg; said hole being sized to receive a fastener which extends through said jamb clip second leg into said door assembly strike jamb.
